(19) United States
(12) Patent Application Publication
(10) Pub. No.: US 2007/0024809 A1
(43) Pub. Date: Feb. 1, 2007

(54) Polarizing illuminant apparatus and image display apparatus

(75) Inventors: Ryusaku Takahashi, Yokohama-shi (JP); Tatsuru Kobayashi, Yokohama-shi (JP); Kazuya Akiyama, Yokohama-shi (JP)

Correspondence Address: NATH & ASSOCIATES PLLC, 112 South West Street, Alexandria, VA, 22314, US

(73) Assignee: VICTOR COMPANY OF JAPAN, LIMITED, Yokohama (JP)

(21) Appl. No.: 11/493,746

(22) Filed: Jul. 27, 2006

(30) Foreign Application Priority Data
Jul. 28, 2005 (JP) P2005-218797
Dec. 8, 2005 (JP) P2005-354531
Dec. 27, 2005 (JP) P2005-374858

(51) Int. Cl. G03B 21/14

(52) U.S. Cl. 353/20; 353/94

(57) ABSTRACT

A polarizing illuminant apparatus includes a surface emission light source 1 that emits a monochroic and indefinitely polarized light, a tabular photonic crystal 2 arranged on a light emitting surface 1a of the surface emission light source 1 to receive the light emitted from the light emitting surface 1a, a quarter wave plate 3 that receives a light emitted from the surface emission light source 1 and transmitted through the photonic crystal 2 and a reflective polarization plate 4 arranged in substantially-parallel with the photonic crystal 2 to receive a light transmitted through the quarter wave plate 3.

### BACKGROUND OF THE INVENTION

1. Field of the Invention

The present invention relates to a polarizing illuminant apparatus that gives off a linearly polarized light to illuminate spatial light modulation elements of an image display apparatus or the likes appropriately, and also relates to an image display apparatus having the polarizing illuminant apparatus.

2. Description of the Related Art

There have been proposed an image display apparatus that includes a plurality of spatial light modulation elements, illuminates these spatial light modulation elements by a lighting apparatus, forms an image by illumination lights transmitted through the spatial light modulation elements, and displays the image on a display.

The spatial light modulation elements display the red, green, and blue components of the image on the display, respectively, and modulate the illumination lights in correspondence with these component images. The lighting apparatus illuminates the spatial light modulation element for displaying the red-component image by a red illumination light, the spatial light modulation element for displaying the green-component image by a green illumination light and the spatial light modulation element for displaying the blue-component image by a blue illumination light.

As the spatial light modulation elements, for instance, liquid crystal display panels for modulating respective directions of polarization of incident illumination lights are available. The use of these spatial light modulation elements performing such a polarization modulation needs polarizing filters, polarizing beam splitters or the likes to align respective polarization directions of illumination lights entering these spatial light modulation elements in one designated direction.

The illumination lights modulated by the spatial light modulation elements are combined in color to form an image, and successively, the image is displayed on a screen or the like.

Japanese Patent Application Laid-Open No. 2004-184777 discloses a lighting apparatus for such an image display apparatus. As shown in FIG. 1, this lighting apparatus utilizes, as a light source, sold light emitting elements 101 forming surface emission light sources (uniform light sources) generating red, green, and blue lights. There is adopted a light emitting diode (LED) as each sold light emitting element. The lighting apparatus utilizes a tabular optical element (so-called “PS conversion element”) that a number of strip-shaped polarizing beam splitters 102 and a number of reflection prisms 103 are stacked on each other alternately. In the lighting apparatus, the so-formed tabular optical element and half wavelength plates 104 are used in order to align respective polarization directions of exit lights from the sold light emitting elements 101 to one designated direction. In this way, the exit lights from these sold light emitting elements 101 enter a beam splitter 105 for polarization combination, providing an illumination light.

Japanese Patent Application Laid-Open No. 2005-5217 discloses a polarizing illuminant apparatus using a surface emission light source. In this polarizing illuminant apparatus, as shown in FIG. 2, a light generated from a surface emission light source 106 is transmitted through a quarter wave plate 107 and a reflective polarization plate 108, and consequently, only a linear polarized light in a designated direction is emitted. The quarter wave plate 107 and the reflective polarization plate 108 are together hemispherical-shaped so as to cover the surface emission light source 106 on a base 109. Additionally, the quarter wave plate 107 and the reflective polarization plate 108 are mounted on the base 109. A base's surface having the surface emission light source 106 mounted thereon constitutes a reflection surface 110.

In the lights emitted from the surface emission light source 106, a light component polarized in a direction different from the designated direction of the linear polarized light is reflected by the reflective polarization plate 108. The reflected light component is transmitted through the quarter wave plate 107 and returns to the reflection surface 110 on the base 109. The light returning to the reflection surface 110 is reflected by the reflection surface 110 so that the direction of polarization rotates by 180 degrees. The reflected light is transmitted through the quarter wave plate 107 again and reaches the reflective polarization plate 108. This light has become a linear polarized light in the designated direction capable of passing through the reflective polarization plate 108. Thus, the same light is transmitted through the reflective polarization plate 108 and emitted outside. In this way, this polarizing illuminant apparatus allows the lights generated from the surface emission light source 106 to be emitted outside after being aligned to linear polarized lights in the designated direction.

Adopting the polarizing illuminant apparatus as a lighting apparatus for an image display apparatus do not need to prepare polarizing filters, polarizing beam splitters or the likes in order to align respective directions of polarization of the illumination lights, since the lights emitted from the polarizing illuminant apparatus has already become the linear polarized lights in the designated direction, whereby the structure of the image display apparatus can be simplified.

The above lighting apparatuses, however, have an issue that a utilization efficiency of light deteriorates remarkably since an etandue of an optical system including the lighting apparatus decreases, while an etandue of a light source increases.

It should be noted here that the “etandue” means a product between an area and a solid angle. The system etandue E′ (system) is represented by the product of an area to be illuminated and a solid angle of the illumination light, while the etandue E′ (lamp) of the light source (lamp) is represented by the product of an area of a light emitting part and a light-distribution solid angle. Then, the integral ratio of the optical system to the lamp is theoretically defied as E′ (system)/E′ (lamp).

In the lighting apparatus of Japanese Patent Application Laid-Open No. 2004-184777, the etandue of the system drops as much as 50 percent because the lights from the respective solid light emitting elements are transmitted to the beam splitter through polarization changing elements (PS conversion elements) composed of the polarizing beam splitters, the reflection prisms and the half wavelength plates. If such polarization changing elements are not employed, then the utilization efficiency of light would be less than 50 percent since only polarization component in a certain direction is usable in the lights from the respective solid light emitting elements.

On the other hand, in a lighting apparatus adopting the polarizing illuminant apparatus disclosed in Japanese Patent Application Laid-Open No. 2005-5217, the etandue of the light source is increased because the area of the light source substantially increases up to an area of the reflection surface.

Moreover, the above lighting apparatuses have an another issue that the utilization ratio of light is remarkably reduced due to both angular characteristics of the reflective polarization plate and the quarter wavelength plate since an exit angle of light rays radiated from the surface emission light source is too large.

### SUMMARY OF THE INVENTION

Under the above-mentioned issues, an object of the present invention is to provide a polarizing illuminant apparatus that can change the polarization of an exit light from a surface emission light source effectively without changing the etandue of a system and the etandue of a light source plate and also an image display apparatus using the polarizing illuminant apparatus.

In order to achieve the above object, a first aspect of the present invention is provided a polarizing illuminant apparatus comprising a surface emission light source that emits a monochroic and indefinitely polarized light, a tabular photonic crystal arranged on a light emitting surface of the surface emission light source to receive the light emitted from the light emitting surface, a quarter wave plate that receives a light emitted from the surface emission light source and transmitted through the photonic crystal and a reflective polarization plate arranged in substantially-parallel with the photonic crystal to receive a light transmitted through the quarter wave plate.

A second aspect of the present invention is provided the polarizing illuminant apparatus of the first aspect of the present invention, further comprising a can-shaped body that accommodates the surface emission light source and that is opened in an exit direction of the light emitted from the surface emission light source, wherein the quarter wave plate and the reflective polarization plate are attached to the can-shaped body so as to close an opening part of the can-shaped body.

A third aspect of the present invention is provided the polarizing illuminant apparatus of the first aspect of the present invention, wherein the photonic crystal is arranged in an area corresponding to the light emission surface of the surface emission light source.

A fourth aspect of the present invention is provided the polarizing illuminant apparatus of the first aspect of the present invention, further comprising a collimator that receives the light emitted from the surface emission light source and transmitted through the photonic crystal, wherein the quarter wave plate receives a light transmitted through the collimator.

A fifth aspect of the present invention is provided the polarizing illuminant apparatus of the first aspect of the present invention, further comprising a light pipe that receives the light emitted from the surface emission light source and transmitted through the photonic crystal and a collimator that receives a light transmitted through the light pipe photonic crystal, wherein the quarter wave plate is arranged on either an incident side of the collimator or an exit side thereof.

A sixth aspect of the present invention is provided the polarizing illuminant apparatus of the fifth aspect of the present invention, wherein the light pipe has a rectangular incident surface and a rectangular exit surface, and the light pipe is tapered so as to have an area of the exit surface larger than an area of the incident surface.

A seventh aspect of the present invention is provided the polarizing illuminant apparatus of the fifth aspect of the present invention, wherein the light pipe has rectangular incident and exit surfaces, and one side of the incident surface is substantially twice as long as one side of the exit surface corresponding to the one side of the incident surface.

A eighth aspect of the present invention is provided an image display apparatus comprising a polarizing illuminant apparatus of the first aspect of the present invention, a spatial light modulation element that is illuminated by an illumination light emitted from the polarizing illuminant apparatus to modulate the illumination light in correspondence with an image signal, and an imaging optics that focuses into an image by the spatial light modulation element.

A ninth aspect of the present invention is provided the image display apparatus of the eighth aspect of the present invention, wherein the spatial light modulation element is a reflective liquid crystal display panel.

### BRIEF DESCRIPTION OF THE DRAWINGS

FIG. 1 is a plan view showing a constitution of a lighting apparatus in a related art image display apparatus;

FIG. 2 is a sectional view showing a constitution of a related art polarizing illuminant apparatus;

FIG. 3 is a sectional view showing a constitution of a polarizing illuminant apparatus in accordance with a first embodiment of the present invention;

FIG. 4 is a plan view showing a constitution of an image display apparatus in accordance with the first embodiment of the present invention;

FIG. 5 is a sectional view showing a constitution of a polarizing illuminant apparatus in accordance with a second embodiment of the present invention;

FIG. 6 is a plan view showing a constitution of an image display apparatus in accordance with the second embodiment of the present invention;

FIG. 7 is a sectional view showing a constitution of a polarizing illuminant apparatus in accordance with a first example of a third embodiment of the present invention;

FIG. 8 is a sectional view showing a constitution of an image display apparatus in accordance with a second example of the third embodiment of the present invention;

FIG. 9 is a plan view showing one structural example of a light pipe in accordance with the third embodiment of the present invention;

FIG. 10 is a diagram showing a relationship between a ratio of entrance opening/exit opening of the light pipe of the third embodiment of the present invention and light flux to be returned to the light source side of surface emission; and

FIG. 11 is a plan view showing a constitution of an image display apparatus in accordance with the third embodiment of the present invention.

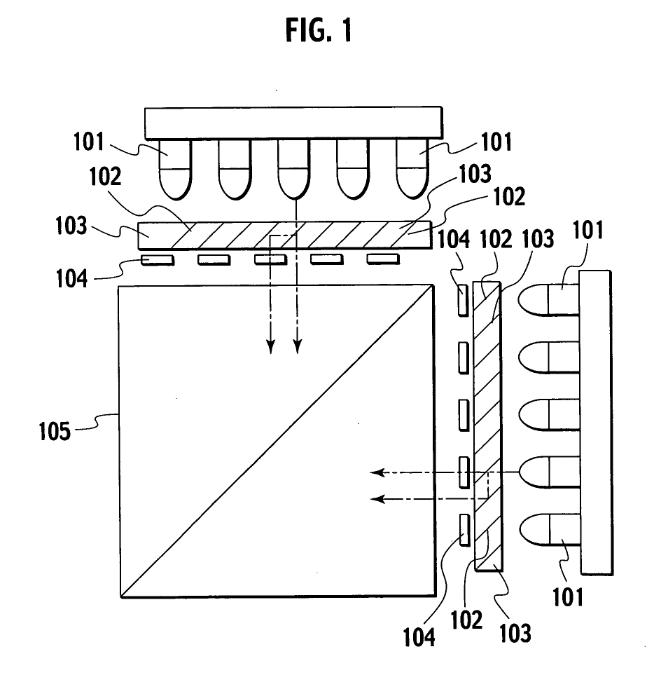

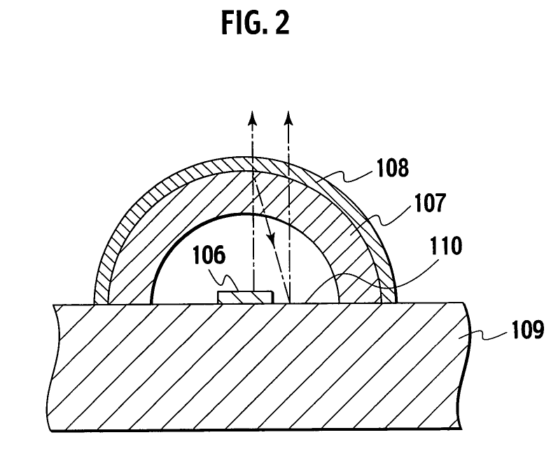

### DETAILED DESCRIPTION OF THE PREFERRED EMBODIMENTS

Embodiments of a polarizing illuminant apparatus of the present invention and an image display apparatus having the polarizing illuminant apparatus will be described below, with reference to drawings.

### 1^{st}. Embodiment

[Polarizing Illuminant Apparatus]

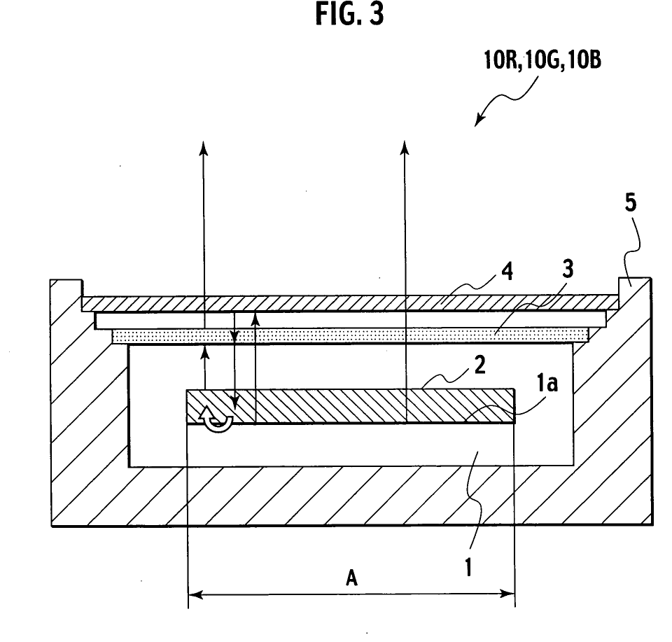

FIG. 3 is a sectional view showing a constitution of a polarizing illuminant apparatus in accordance with a first embodiment of the present invention.

As shown in FIG. 3, the polarizing illuminant apparatus 10R (10G, 10B) has a surface emission light source 1 emitting a monochroic and indefinitely polarized light. As the surface emission light source 1, there are available light emission diode (LED) and electroluminescence element (EL) both of which are solid light emitting elements. In case of the light emission diode as the surface emission light source 1, it is made of AlGaAs, AlGaInP or GaAsP (as materials emitting red light), InGaN or AlGaInP (as materials emitting green light) or InGaN (as material emitting blue light). Note that the polarizing illuminant apparatus 10R is a polarizing illuminant apparatus emitting red light, the polarizing illuminant apparatus 10G is a polarizing illuminant apparatus emitting green light, and the polarizing illuminant apparatus, 10B is a polarizing illuminant apparatus emitting blue light.

On a light emitting surface 1a of the surface emission light source 1, there is arranged a tabular photonic crystal 2 that receives a light emitted from the light emitting surface 1a. Note that the photonic crystal 2 is adopted as a semiconductor forming the surface emission light source 1, too.

The photonic crystal (or photonic lattice) is a crystal body where two kinds of materials having different dielectric constants are arranged in cycles of wavelength order. If allowing an artificial substance having two kinds of substances of different dielectric constants to receive a light, then the light proceeds in the artificial substance while being affected by the periodicity of dielectric constants. This phenomenon is something akin to a situation that an electron proceeds in a crystal having atoms lined periodically. Such an artificial substance is therefore called to as “photonic crystal” in the sense of a crystal against a photon.

Further, a photon in the photonic crystal has an energy band structure like an electron in a solid and various unique characters. As well as referring to the dispersion relation of an electron in a solid as the “electron band”, the dispersion relation of the light quantum in the photonic crystal will be referred to as the “photonic band”. The photonic band, as similar to the electron band, has a band gap (energy area having no state), which is called the “photonic band gap”. In the same manner that an electron has an energy corresponding to the band gap cannot exist in a crystal, a light corresponding to the photonic band gap cannot exist in the photonic crystal. Therefore, if radiating a light with a wavelength in the vicinity of such a predetermined wavelength to the photonic crystal, the light is reflected at 100%. Including this character, the light in the photonic crystal has various characters reflecting the photonic band structure.

It is desirable that the photonic crystal 2 is arranged in an area (e.g. 2 mm×4 mm) corresponding to the light emitting surface 1a of the surface emission light source 1, as shown with arrow A of FIG. 3.

In this polarizing illuminant apparatus, lights emitted from the surface emission light source 1 and successively transmitted through the photonic crystal 2 are received by a quarter wave plate 3. Although the lights emitted from the light emitting surface 1a are indefinitely polarized lights, each phase of respective polarized components is rotated by 90 degrees since the light transmits the quarter wave plate 3. A quartz plate is available as the quarter wave plate 3. Note that an interval between the photonic crystal 2 and the quarter wave plate 3 is desirable to be less than approx. 0.5 mm.

The lights transmitted through the quarter wave plate 3 enter a reflective polarization plate 4. This reflective polarization plate 4 is arranged in substantially-parallel with the photonic crystal 2. A polarization plate constructed with a so-called “wire grid” structure is available as the reflective polarization plate 4. As for the reflective polarization plate 4, only a light of a linear polarization component in a designated direction is transmitted through the reflective polarization plate 4 to be an exit light, while a light of a linear polarization component perpendicular to the designated direction is reflected by the reflective polarization plate 4. Note that the reflective polarization plate 4 is arranged so that its polarization direction allowing a transmission of the light is identical to either a direction of +45 degrees to the direction of an optical axis (crystal axis) of the quarter wave plate 3 or a direction of −45 degrees to the direction of the optical axis.

The light reflected by the reflective polarization plate 4 returns to the quarter wave plate 3. Since the reflected light is transmitted through the quarter wave plate 3, a phase of the polarization is rotated by 90 degrees. That is, the linear polarization component is changed to a circular polarization component and the light returns to the photonic crystal 2. In the photonic crystal 2, a phase of the polarization component of the return light is rotated by 180 degrees. That is, the return light is reflected by the photonic crystal 2. Namely, the light returning to the photonic crystal 2 and the light reflected by the photonic crystal 2 form circularly polarized lights in opposite directions. In the light reflected by the photonic crystal 2, there are included, besides a light reflected on the surface of the photonic crystal 2, a light reflected in the photonic crystal 2 and a light reflected on a boundary surface between the photonic crystal 2 and the light emitting surface 1a of the surface emission light source 1.

The light reflected by the photonic crystal 2 is transmitted through the quarter wave plate 3 and reaches the reflective polarization plate 4. Then, this light has become a linear polarized light in a direction perpendicular to the direction of polarization at the reflection by the reflective polarization plate 4, that is, a linear polarized light in a designated direction that passes through the reflective polarization plate 4. Therefore, this light becomes an exit light after being transmitted through the reflective polarization plate 4.

In this way, in the polarizing illuminant apparatus, the lights generated from the surface emission light source 1 are aligned to linear polarized lights in a designated direction effectively, providing an exit light. The efficiency of polarization change is improved at least 20% in comparison with an arrangement having no photonic crystal. Additionally, in the polarizing illuminant apparatus, since the photonic crystal 2 reflecting a reflected light from the reflective polarization plate 4 is arranged in the area corresponding to the light emitting surface 1a of the surface emission light source 1, there is no possibility that an etandue of the light source increases in comparison with the arrangement having no photonic crystal.

In the polarizing illuminant apparatus, the surface emission light source 1 is accommodated in a can-shaped body 5 that is opened in the exit direction of the light emitted from the surface emission light source 1. The quarter wave plate 3 and the reflective polarization plate 4 are attached to the can-shaped body 5 to close its opening part. Thus, the surface emission light source 1 and the photonic crystal 2 are accommodated in the can-shaped body 5 in a tightly-sealed condition brought by the quarter wave plate 3 and the reflective polarization plate 4.

Accordingly, in the polarizing illuminant apparatus, it is prevented that dust contaminates or adheres to the surface emitting surface 1a and the photonic crystal 2.

[Image Display Apparatus]

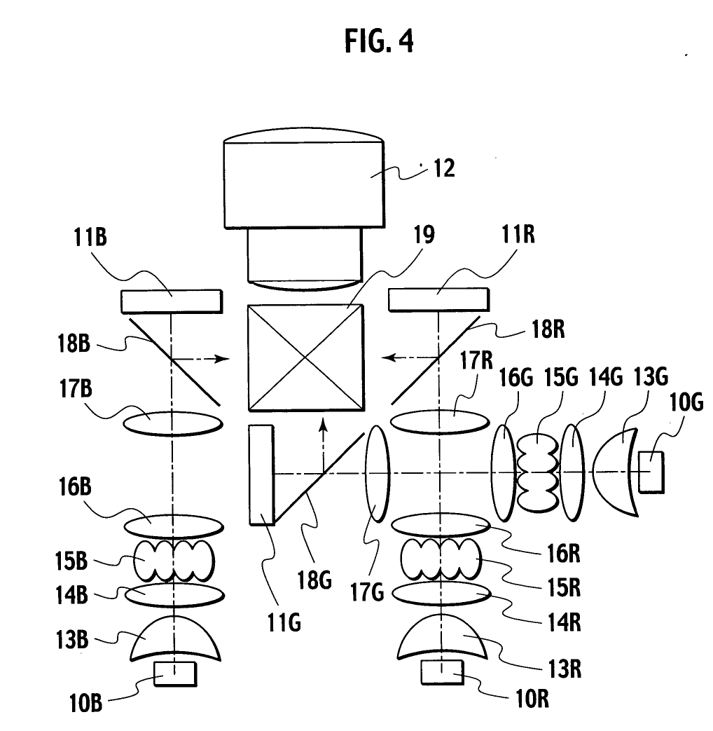

FIG. 4 is a plan view showing a constitution of an image display apparatus in accordance with the first embodiment of the present invention.

As shown in FIG. 4, this image display apparatus comprises the above-mentioned polarizing illuminant apparatuses 10R, 10G, 10B, spatial light modulation elements 11R, 11G, 11B illuminated by lights generated from the polarizing illuminant apparatuses 10R, 10G, 10B to modulate the illumination lights in correspondence with image signals and a projection lens 12 forming an imaging optics for producing an image through the spatial light modulation elements 11R, 11G, 11B. Thus, this image display apparatus illuminates the spatial light modulation elements 11R, 11G, 11B by means of the corresponding polarizing illuminant apparatuses 10R, 10G, 10B, next combines the illumination lights through the spatial light modulation elements 11R, 11G, 11B in color thereby producing an image and finally displays the image.

The spatial light modulation elements 11R, 11G, 11B display a red component of the image on display, its green component and its blue component respectively and modulate the illumination lights in polarization corresponding to these images. The spatial light modulation elements 11R, 11G, 11B are formed by reflective light modulation elements [i.e. so-called “LCOS (Liquid Crystal on Silicon)” (reflective liquid crystal display panel) and “DMD”] and reflect incident illumination lights in modulation.

In this image display apparatus, the polarizing illuminant apparatuses 10R, 10G, 10B generate a red light, a green light and a blue light, respectively. The polarizing illuminant apparatus 10R illuminates the spatial light modulation element 11R displaying a red component image with the red illumination light, while the polarizing illuminant apparatus 10G illuminates the spatial light modulation element 11G displaying a green component image with the green illumination light. Similarly, the polarizing illuminant apparatus 10B illuminates the spatial light modulation element 11B displaying a blue component image with the blue illumination light.

The illumination light generated from the polarizing illuminant apparatus 10R for red is transmitted through a first collimator lens 13R and a second collimator lens 14R and subsequently equalized in terms of illumination distribution through a flyeye-lens-array 15R. The flyeye-lens-array 15R is provided, on both sides thereof, with a plurality of micro lenses (converging lenses) in matrix arrangement. The illumination light transmitted through the flyeye-lens-array 15R enters a polarization beam splitter 18R through a first field lens 16R and a second field lens 17R. This polarization beam splitter 18R, which is a reflective polarization plate, is slanted to an optic axis of the incident illumination light by 45 degrees and arranged so that the polarization direction of the incident light coincides with a P polarized light. The illumination light entering the polarization beam splitter 18R is transmitted through it and enters the spatial light modulation element 11R for red. The red illumination light is polarized in modulation by the spatial light modulation element 11R, corresponding to a red-component image signal and reflected as a red image light and enters the polarization beam splitter 18R again. The image light entering the polarization beam splitter 18R again is reflected by the polarization beam splitter 18R and enters a color combining prism (cross dichroic prism) 19.

The illumination light generated from the polarizing illuminant apparatus 10G for green is transmitted through a first collimator lens 13G and a second collimator lens 14G and subsequently equalized in terms of illumination distribution through a flyeye-lens-array 15G. The flyeye-lens-array 15G is provided, on both sides thereof, with a plurality of micro lenses (converging lenses) in matrix arrangement. The illumination light transmitted through the flyeye-lens-array 15G enters a polarization beam splitter 18R through a first field lens 16G and a second field lens 17G. This polarization beam splitter 18G, which is a reflective polarization plate, is slanted to an optic axis of the incident illumination light by 45 degrees and arranged so that the polarization direction of the incident light coincides with a P polarized light. The illumination light entering the polarization beam splitter 18G is transmitted through it and enters the spatial light modulation element 11G for green. The green illumination light is polarized in modulation by the spatial light modulation element 11G, corresponding to a green-component image signal and reflected as a green image light and enters the polarization beam splitter 18G again. The image light entering the polarization beam splitter 18G again is reflected by the polarization beam splitter 18G and enters the color combining prism 19.

The illumination light generated from the polarizing illuminant apparatus 10B for blue is transmitted through a first collimator lens 13B and a second collimator lens 14B and subsequently equalized in terms of illumination distribution through a flyeye-lens-array 15B. The flyeye-lens-array 15B is provided, on both sides thereof, with a plurality of micro lenses (converging lenses) in matrix arrangement. The illumination light transmitted through the flyeye-lens-array 15B enters a polarization beam splitter 18B through a first field lens 16B and a second field lens 17B. This polarization beam splitter 18B, which is a reflective polarization plate, is slanted to an optic axis of the incident illumination light by 45 degrees and arranged so that the polarization direction of the incident light coincides with a P polarized light. The illumination light entering the polarization beam splitter 18B is transmitted through it and enters the spatial light modulation element 11B for blue. The blue illumination light is polarized in modulation by the spatial light modulation element 11B, corresponding to a blue-component image signal and reflected as a blue image light and enters the polarization beam splitter 18B again. The image light entering the polarization beam splitter 18B again is reflected by the polarization beam splitter 18B and enters the color combining prism 19.

The image lights of red, green and blue entering the color combining prism 19 are combined in color and enter the projection lens 12. This projection lens 12 projects the image lights of respective colors on a not shown screen and forms an image in enlargement, performing an image displaying.

Meanwhile, when adopting the reflective spatial light modulation elements, such as so-called “LCOS”, for the spatial light modulation elements 11R, 11G, 11B, like as the above-mentioned image display apparatus does, unnecessary lights at black displaying return toward the light sources. However, according to the image display apparatus of this embodiment, the unnecessary lights at black displaying returning to the light sources are suppressed from being reflected by the respective polarizing illuminant apparatuses 10R, 10G, 10B again, so that an occurrence of so-called “black floating” phenomenon can be restrained.

That is, in this image display apparatus, the illumination lights reflected by the spatial light modulation elements 11R, 11G, 11B at black displaying return to the polarizing illuminant apparatuses 10R, 10G, 10B, in the form of linear polarized lights having the same directions of polarization as the illumination lights from the polarizing illuminant apparatuses 10R, 10G, 10B, respectively. Each return light is transmitted through the reflective polarization plate 4 and further the quarter wave plate 3. When passing through the quarter wave plate 3, this return light is changed to a circularly polarized light. Then, the return light is reflected by the photonic crystal 2, in the form of a circularly polarized light in the opposite direction. When reaching the reflective polarization plate 4 through the quarter wave plate 3, this reflected light is reflected by the reflective polarization plate 4 since the same light has become a linear polarized light in a direction unable to be transmitted through the reflective polarization plate 4. Then, this reflected light is transmitted through the quarter wave plate 3 again and reaches the photonic crystal 2. Then, the reflected light is further reflected by the photonic crystal 2 and reaches the reflective polarization plate 4 through the quarter wave plate 3. Although this light has become a linear polarized light in a direction to be transmitted through the reflective polarization plate 4, it is attenuated due to such multiple-reflections, so that respective intensities of the lights reaching the spatial light modulation elements 11R, 11G, 11B are reduced.

Additionally, in the image display apparatus of the embodiment, there is no possibility that an etandue of each light source increases. Further, since the efficiency in availability of lights from the light sources is high, the image display apparatus can display high-quality and bright images.

Note that the image display apparatus of this embodiment is not limited to the above-mentioned constitution adopting reflective spatial light modulation elements as the spatial light modulation elements 11R, 11G, 11B and therefore, transmission light modulation elements may be adopted as the spatial light modulation elements 11R, 11G, 11B. Additionally, the flyeye-lens-arrays 15R, 15G, 15B may be replaced with either rod integrators or light-tunnel (light pipe) integrators.

### 2^{nd}. Embodiment

[Polarizing Illuminant Apparatus]

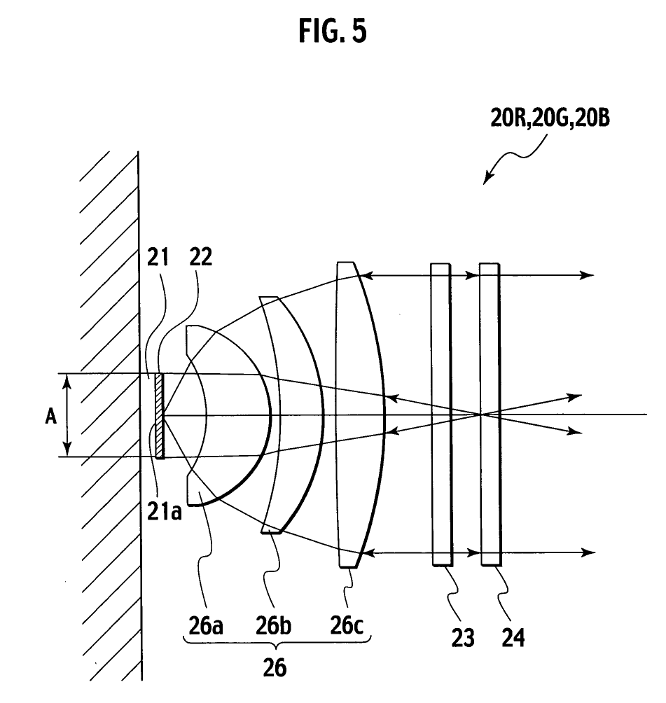

FIG. 5 is a sectional view showing a constitution of a polarizing illuminant apparatus in accordance with a second embodiment of the present invention. In the second embodiment, constituents identical to those in the first embodiment are indicated with the same reference numerals, respectively.

As shown in FIG. 5, a polarizing illuminant apparatus 20R (20G, 20B) has a surface emission light source 21 emitting a monochroic and indefinitely polarized light. As the surface emission light source 21, there are available light emission diode (LED) and electroluminescence element (EL) both of which are solid light emitting elements.

On a light emitting surface 21a of the surface emission light source 21, there is arranged a tabular photonic crystal 22 that receives a light emitted from the light emitting surface 21a. Note that the photonic crystal 22 is adopted as a semiconductor forming the surface emission light source 21, too.

It is desirable that the photonic crystal 22 is arranged in an area (e.g. 2 mm×4 mm) corresponding to the light emitting surface 21a of the surface emission light source 21, as shown with arrow A of FIG. 5.

In this polarizing illuminant apparatus, lights emitted from the surface emission light source 21 are transmitted through the photonic crystal 22 and sequent collimator lenses 26a, 26b, 26c for parallel pencil. Thereafter, the lights are received by a quarter wave plate 23. Although the lights emitted from the light emitting surface 21a are indefinitely polarized lights, each phase of respective polarized components is rotated by 90 degrees since the light transmits the quarter wave plate 23. A quartz plate is available as the quarter wave plate 23.

The lights transmitted through the quarter wave plate 23 enter a reflective polarization plate 24. This reflective polarization plate 24 is arranged in substantially-parallel with the photonic crystal 22. A polarization plate constructed with a wire grid structure is available as the reflective polarization plate 24. As for the reflective polarization plate 24, only a light of a linear polarization component in a designated direction is transmitted through the reflective polarization plate 24 to be an exit light, while a light of a linear polarization component perpendicular to the designated direction is reflected by the reflective polarization plate 24. Note that the reflective polarization plate 24 is arranged so that its polarization direction allowing a transmission of the light is identical to either a direction of +45 degrees to the direction of an optical axis (crystal axis) of the quarter wave plate 23 or a direction of −45 degrees to the direction of the optical axis.

The reflected light by the reflective polarization plate 24 returns to the quarter wave plate 23. Since the reflected light is transmitted through the quarter wave plate 23, a phase of the polarization is rotated by 90 degrees, so that the linear polarization component is changed to a circular polarization component. After passing through the collimator lenses 26a, 26b, 26c, the reflected light returns to the photonic crystal 22. Then, the light returning to the photonic crystal 22 is reflected while its polarization component is rotated by 180 degrees.

That is, the light returning to the photonic crystal 22 and the light reflected by the photonic crystal 22 form circularly polarized lights in opposite directions. In the light reflected by the photonic crystal 22, there are included, besides a light reflected on the surface of the photonic crystal 22, a light reflected in the photonic crystal 22 and a light reflected on a boundary surface between the photonic crystal 22 and the light emitting surface 21a of the surface emission light source 21.

The light reflected by the photonic crystal 22 is transmitted through the collimator lenses 26a, 26b, 26c and the quarter wave plate 23 and reaches the reflective polarization plate 24. Then, this light has become a linear polarized light in a direction perpendicular to the direction of polarization at the reflection by the reflective polarization plate 24, that is, a linear polarized light in a designated direction that passes through the reflective polarization plate 24. Therefore, this light becomes an exit light after being transmitted through the reflective polarization plate 24.

In this way, in the polarizing illuminant apparatus, the lights generated from the surface emission light source 21 are aligned to linear polarized lights in a designated direction effectively, providing an exit light. The efficiency of polarization change is improved at least 20% in comparison with an arrangement having no photonic crystal. Additionally, in the polarizing illuminant apparatus, since the photonic crystal 22 reflecting a reflected light from the reflective polarization plate 24 is arranged in the area corresponding to the light emitting surface 21a of the surface emission light source 21, there is no possibility that an etandue of the light source increases in comparison with the arrangement having no photonic crystal.

[Image Display Apparatus]

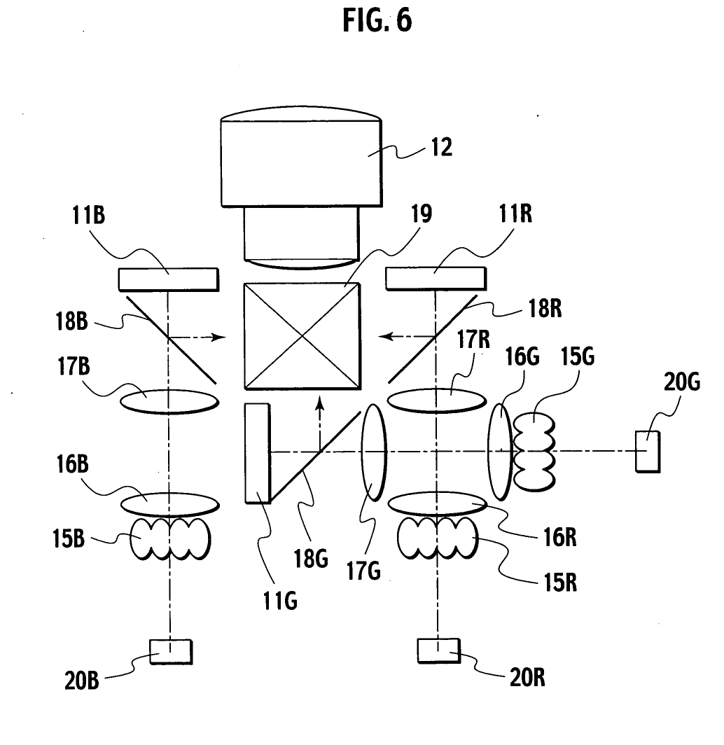

FIG. 6 is a plan view showing a constitution of an image display apparatus in accordance with the second embodiment of the present invention. In the second embodiment, constituents identical to those in the first embodiment are indicated with the same reference numerals, respectively.

As shown in FIG. 6, this image display apparatus comprises the above-mentioned polarizing illuminant apparatuses 20R, 20G, 20B, spatial light modulation elements 11R, 11G, 11B illuminated by lights generated from the polarizing illuminant apparatuses 20R, 20G, 20B to modulate the illumination lights in correspondence with image signals and a projection lens 12 forming an imaging optics for producing an image through the spatial light modulation elements 11R, 11G, 11B. Thus, this image display apparatus illuminates the spatial light modulation elements 11R, 11G, 11B by means of the corresponding polarizing illuminant apparatuses 20R, 20G, 20B, next combines the illumination lights through the spatial light modulation elements 11R, 11G, 11B in color thereby producing an image and finally displays the image.

The spatial light modulation elements 11R, 11G, 11B display a red component of the image on display, its green component and its blue component respectively and modulate the illumination lights in polarization corresponding to these images. The spatial light modulation elements 11R, 11G, 11B are formed by reflective light modulation elements [i.e. so-called “LCOS” (reflective liquid crystal display panel) and “DMD”] and reflect incident illumination lights in modulation.

In this image display apparatus, the polarizing illuminant apparatuses 20R, 20G, 20B generate a red light, a green light and a blue light, respectively. The polarizing illuminant apparatus 20R illuminates the spatial light modulation element 11R displaying a red component image with the red illumination light, while the polarizing illuminant apparatus 20G illuminates the spatial light modulation element 11G displaying a green component image with the green illumination light. Similarly, the polarizing illuminant apparatus 20B illuminates the spatial light modulation element 11B displaying a blue component image with the blue illumination light.

The illumination light generated from the polarizing illuminant apparatus 20R for red is equalized in terms of illumination distribution through a flyeye-lens-array 15R. The flyeye-lens-array 15R is provided, on both sides thereof, with a plurality of micro lenses (converging lenses) in matrix arrangement. The illumination light transmitted through the flyeye-lens-array 15R enters a polarization beam splitter 18R through a first field lens 16R and a second field lens 17R. This polarization beam splitter 18R, which is a reflective polarization plate, is slanted to an optic axis of the incident illumination light by 45 degrees and arranged so that the polarization direction of the incident light coincides with a P polarized light. The illumination light entering the polarization beam splitter 18R is transmitted through it and enters the spatial light modulation element 11R for red. The red illumination light is polarized in modulation by the spatial light modulation element 11R, corresponding to a red-component image signal and reflected as a red image light and enters the polarization beam splitter 18R again. The image light entering the polarization beam splitter 18R again is reflected by the polarization beam splitter 18R and enters a color combining prism (cross dichroic prism) 19.

The illumination light generated from the polarizing illuminant apparatus 20G for green is equalized in terms of illumination distribution through a flyeye-lens-array 15G. The flyeye-lens-array 15G is provided, on both sides thereof, with a plurality of micro lenses (converging lenses) in matrix arrangement. The illumination light transmitted through the flyeye-lens-array 15G enters a polarization beam splitter 18R through a first field lens 16G and a second field lens 17G This polarization beam splitter 18G which is a reflective polarization plate, is slanted to an optic axis of the incident illumination light by 45 degrees and arranged so that the polarization direction of the incident light coincides with a P polarized light. The illumination light entering the polarization beam splitter 18G is transmitted through it and enters the spatial light modulation element 11G for green. The green illumination light is polarized in modulation by the spatial light modulation element 11G corresponding to a green-component image signal and reflected as a green image light and enters the polarization beam splitter 18G again. The image light entering the polarization beam splitter 18G again is reflected by the polarization beam splitter 18G and enters the color combining prism 19.

The illumination light generated from the polarizing illuminant apparatus 20B for blue is equalized in terms of illumination distribution through a flyeye-lens-array 15B. The flyeye-lens-array 15B is provided, on both sides thereof, with a plurality of micro lenses (converging lenses) in matrix arrangement. The illumination light transmitted through the flyeye-lens-array 15B enters a polarization beam splitter 18B through a first field lens 16B and a second field lens 17B. This polarization beam splitter 18B, which is a reflective polarization plate, is slanted to an optic axis of the incident illumination light by 45 degrees and arranged so that the polarization direction of the incident light coincides with a P polarized light. The illumination light entering the polarization beam splitter 18B is transmitted through it and enters the spatial light modulation element 11B for blue. The blue illumination light is polarized in modulation by the spatial light modulation element 11B, corresponding to a blue-component image signal and reflected as a blue image light and enters the polarization beam splitter 18B again. The image light entering the polarization beam splitter 18B again is reflected by the polarization beam splitter 18B and enters the color combining prism 19.

The image lights of red, green and blue entering the color combining prism 19 are combined in color and enter the projection lens 12. This projection lens 12 projects the image lights of respective colors on a not shown screen and forms an image in enlargement, performing an image displaying.

Meanwhile, when adopting the reflective spatial light modulation elements, such as so-called “LCOS”, for the spatial light modulation elements 11R, 11G, 11B, like as the above-mentioned image display apparatus does, unnecessary lights at black displaying return toward the light sources. However, according to the image display apparatus of this embodiment, the unnecessary lights at black displaying returning to the light sources are suppressed from being reflected by the respective polarizing illuminant apparatuses 20R, 20G, 20B again, so that an occurrence of so-called “black floating” phenomenon can be restrained.

That is, in this image display apparatus, the illumination lights reflected by the spatial light modulation elements 11R, 11G, 11B at black displaying return to the polarizing illuminant apparatuses 20R, 20G, 20B, in the form of linear polarized lights having the same directions of polarization as the illumination lights from the polarizing illuminant apparatuses 20R, 20G, 20B, respectively. In each of the polarizing illuminant apparatuses 20R, 20G, 20B, each return light is transmitted through the reflective polarization plate 4 and further the quarter wave plate 3 (we continue our descriptions while omitting the collimator lenses 6 because of the descriptions about polarization). When passing through the quarter wave plate 3, this return light is changed to a circularly polarized light. Then, the return light is reflected by the photonic crystal 2, in the form of a circularly polarized light in the opposite direction. When reaching the reflective polarization plate 4 through the quarter wave plate 3, this reflected light is reflected by the reflective polarization plate 4 since the same light has become a linear polarized light in a direction unable to be transmitted through the reflective polarization plate 4. Then, this reflected light is transmitted through the quarter wave plate 3 again and reaches the photonic crystal 2. Then, the reflected light is further reflected by the photonic crystal 2 and reaches the reflective polarization plate 4 through the quarter wave plate 3. Although this light has become a linear polarized light in a direction to be transmitted through the reflective polarization plate 4, it is attenuated due to such multiple-reflections, so that respective intensities of the lights reaching the spatial light modulation elements 11R, 11G, 11B are reduced.

Additionally, in the image display apparatus of the embodiment, there is no possibility that an etandue of each light source increases. Further, as the utilization efficiency of light from the light sources is high, the image display apparatus can display high-quality and bright images.

Note that the image display apparatus of this embodiment is not limited to the above-mentioned constitution adopting reflective spatial light modulation elements as the spatial light modulation elements 11R, 11G, 11B and therefore, transmission light modulation elements may be adopted as the spatial light modulation elements 11R, 11G, 11B. Additionally, the flyeye-lens-arrays 15R, 15G, 15B may be replaced with either rod integrators or light-tunnel (light pipe) integrators.

### 3^{rd}. Embodiment

### 1^{st}. Example

[Polarizing Illuminant Apparatus]

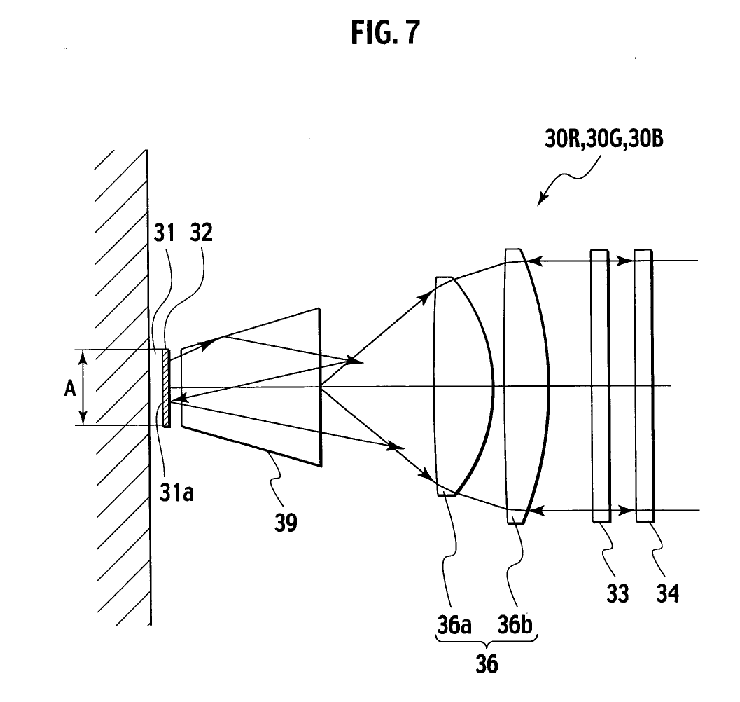

FIG. 7 is a sectional view showing a constitution of a polarizing illuminant apparatus in accordance with a first example of a third embodiment of the present invention. In this example of the third embodiment, constituents identical to those in the second embodiment are indicated with the same reference numerals, respectively.

As shown in FIG. 7, a polarizing illuminant apparatus 30R (30G, 30B) has a surface emission light source 31 emitting a monochroic and indefinitely polarized light. As the surface emission light source 31, there are available light emission diode (LED) and electroluminescence element (EL) both of which are solid light emitting elements.

On a light emitting surface 31a of the surface emission light source 31, there is arranged a tabular photonic crystal 32 that receives a light emitted from the light emitting surface 31a. Note that the photonic crystal 32 is adopted as a semiconductor forming the surface emission light source 31, too.

It is desirable that the photonic crystal 32 is arranged in an area (e.g. 2 mm×4 mm) corresponding to the light emitting surface 31a of the surface emission light source 31, as shown with arrow A of FIG. 7.

In this polarizing illuminant apparatus, lights emitted from the surface emission light source 31 are transmitted through the photonic crystal 32, a light pipe 39 and collimator lenses 36a, 36b for parallel pencil, in order. Thereafter, the lights are received by a quarter wave plate 33. Although the lights emitted from the light emitting surface 31a are indefinitely polarized lights, each phase of respective polarized components is rotated by 90 degrees since the light transmits the quarter wave plate 33. A quartz plate is available as the quarter wave plate 33.

The lights transmitted through the quarter wave plate 33 enter a reflective polarization plate 34. This reflective polarization plate 34 is arranged in substantially-parallel with the photonic crystal 32. A polarization plate constructed with a wire grid structure is available as the reflective polarization plate 34. As for this reflective polarization plate 34, only a light of a linear polarization component in a designated direction is transmitted through the reflective polarization plate 34 to be an exit light, while a light of a linear polarization component perpendicular to the designated direction is reflected. Note that the reflective polarization plate 34 is arranged so that its polarization direction allowing a transmission of the light is identical to either a direction of +45 degrees to the direction of an optical axis (crystal axis) of the quarter wave plate 33 or a direction of −45 degrees to the direction of the optical axis.

The reflected light by the reflective polarization plate 34 returns to the quarter wave plate 33. Since the reflected light is transmitted through the quarter wave plate 33, a phase of the polarization is rotated by 90 degrees, so that the linear polarization component is changed to a circular polarization component. After passing through the collimator lenses 36a, 36b and further the light pipe 39, the reflected light returns to the photonic crystal 32. Then, the light returning to the photonic crystal 32 is reflected while its polarization component is rotated by 180 degrees.

That is, the light returning to the photonic crystal 32 and the light reflected by the photonic crystal 32 provide circularly polarized lights in opposite directions. In the light reflected by the photonic crystal 32, there are included, besides a light reflected on the surface of the photonic crystal 32, a light reflected in the photonic crystal 32 and a light reflected on a boundary surface between the photonic crystal 32 and the light emitting surface 31a of the surface emission light source 31.

The light reflected by the photonic crystal 32 is transmitted through the light pipe 39 again, the collimator lenses 36a, 36b and the quarter wave plate 33 and brought to the reflective polarization plate 34. Then, this light has become a linear polarized light in a direction perpendicular to the direction of polarization at the reflection by the reflective polarization plate 34, that is, a linear polarized light in a designated direction that passes through the reflective polarization plate 34. Therefore, this light becomes an exit light after being transmitted through the reflective polarization plate 34.

In this way, in the polarizing illuminant apparatus, the lights generated from the surface emission light source 31 are aligned to linear polarized lights in a designated direction effectively, providing an exit light. The efficiency of polarization change is improved at least 20% in comparison with an arrangement having no photonic crystal. Additionally, in the polarizing illuminant apparatus, since the photonic crystal 32 reflecting a reflected light from the reflective polarization plate 34 is arranged in the area corresponding to the light emitting surface 31a of the surface emission light source 31, there is no possibility that an etandue of the light source increases in comparison with the arrangement having no photonic crystal.

### 2^{nd}. Example

[Polarizing Illuminant Apparatus]

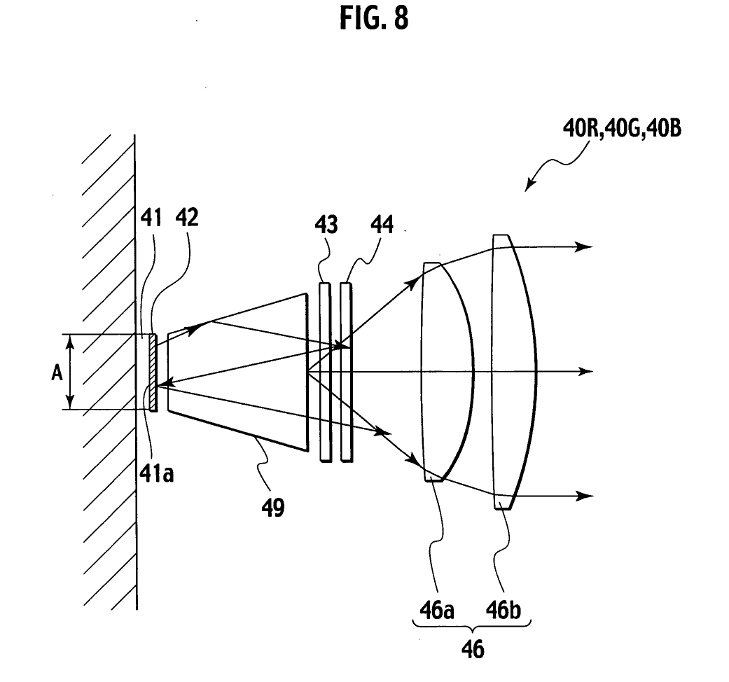

FIG. 8 is a sectional view showing a constitution of a polarizing illuminant apparatus in accordance with a second example of the third embodiment of the present invention. In the second example of the third embodiment, constituents identical to those in the first embodiment are indicated with the same reference numerals, respectively.

As shown in FIG. 8, a polarizing illuminant apparatus 40R (40G, 40B) has a surface emission light source 41 emitting a monochroic and indefinitely polarized light. As the surface emission light source 41, there are available light emission diode (LED) and electroluminescence element (EL) both of which are solid light emitting elements.

On a light emitting surface 41a of the surface emission light source 41, there is arranged a tabular photonic crystal 42 that receives a light emitted from the light emitting surface 41a. Note that the photonic crystal 42 is adopted as a semiconductor forming the surface emission light source 41, too.

It is desirable that the photonic crystal 42 is arranged in an area (e.g. 2 mm×4 mm) corresponding to the light emitting surface 41a of the surface emission light source 41, as shown with arrow A of FIG. 8.

In this polarizing illuminant apparatus, lights emitted from the surface emission light source 41 are transmitted through the photonic crystal 42 and a light pipe 49. Thereafter, the lights are received by a quarter wave plate 43. Although the lights emitted from the light emitting surface 41a are indefinitely polarized lights, each phase of respective polarized components is rotated by 90 degrees since the light transmits the quarter wave plate 43. A quartz plate is available as the quarter wave plate 43.

The lights transmitted through the quarter wave plate 43 enter a reflective polarization plate 44. This reflective polarization plate 44 is arranged in substantially-parallel with the photonic crystal 42. A polarization plate constructed in a wire grid method is available as the reflective polarization plate 44. In this reflective polarization plate 44, only a light of a linear polarization component in a designated direction transmits to become an exit light, while a light of a linear polarization component perpendicular to the designated direction is reflected. This transmitted exit light is transmitted through collimator lenses 46a, 46b for parallel pencil and thereafter, the exit light enters an optical system in a subsequent stage. Note that the reflective polarization plate 44 is arranged so that its polarization direction allowing a transmission of the light is identical to either a direction of +45 degrees to the direction of an optical axis (crystal axis) of the quarter wave plate 43 or a direction of −45 degrees to the direction of the optical axis.

The reflected light by the reflective polarization plate 44 returns to the quarter wave plate 43. Since the reflected light is transmitted through the quarter wave plate 43, a phase of the polarization is rotated by 90 degrees and additionally, the linear polarization component is changed to a circular polarization component. After passing through the light pipe 49, the reflected light returns to the photonic crystal 42. Then, the light returning to the photonic crystal 42 is reflected while its polarization component is rotated by 180 degrees.

That is, the light returning to the photonic crystal 42 and the light reflected by the photonic crystal 42 form circularly polarized lights in opposite directions. In the light reflected by the photonic crystal 42, there are included, besides a light reflected on the surface of the photonic crystal 42, a light reflected in the photonic crystal 42 and a light reflected on a boundary surface between the photonic crystal 42 and the light emitting surface 41a of the surface emission light source 41.

The light reflected by the photonic crystal 42 is transmitted through the light pipe 49 again and the quarter wave plate 43 and reaches the reflective polarization plate 44. Then, this light has become a linear polarized light in a direction perpendicular to the direction of polarization at the reflection by the reflective polarization plate 44, that is, a linear polarized light in a designated direction that passes through the reflective polarization plate 44. Therefore, this light becomes an exit light after being transmitted through the reflective polarization plate 44.

In this way, in the polarizing illuminant apparatus, the lights generated from the surface emission light source 41 are aligned to linear polarized lights in a designated direction effectively, providing an exit light. The efficiency of polarization change is improved at least 20% in comparison with an arrangement having no photonic crystal. Additionally, in the polarizing illuminant apparatus, since the photonic crystal 42 reflecting a reflected light from the reflective polarization plate 44 is arranged in the area corresponding to the light emitting surface 41a of the surface emission light source 41, there is no possibility that an etandue of the light source increases in comparison with the arrangement having no photonic crystal.

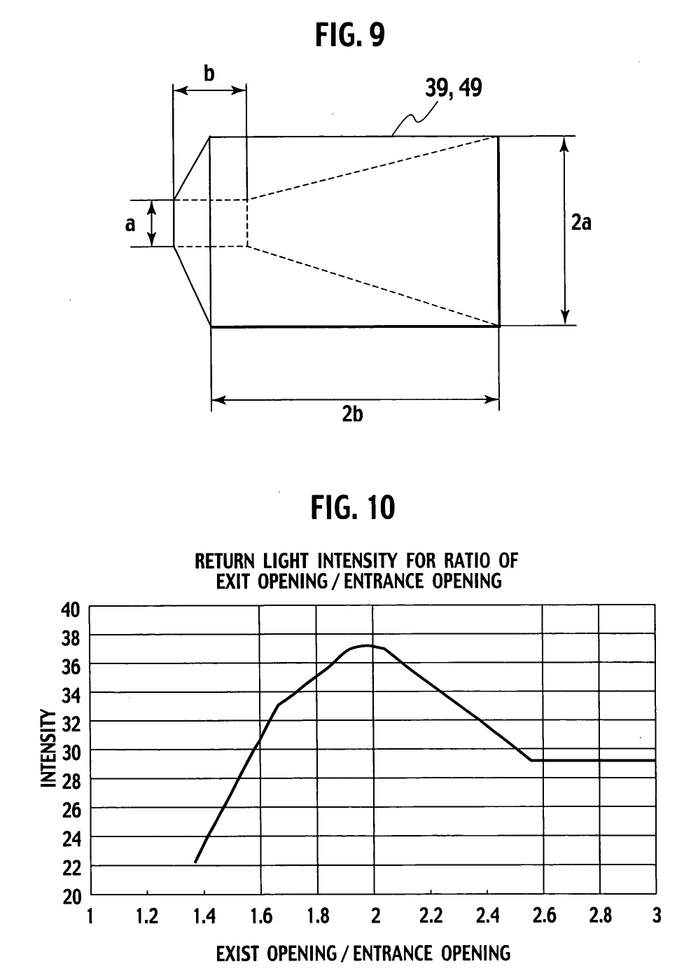

Referring to FIG. 9, we now described the light pipe 39 (49) that is applied to each of the polarizing illuminant apparatuses 30R, 30G, 30B, (40R, 40G, 40B). As shown in the figure, the light pipe 39 (49) has rectangular incident and exit surfaces and is tapered so that an area of the exit surface is larger than that of the incident surface. Due to the tapered configuration of the light pipe 39 (49), it is possible to send back the light to the surface light source effectively. That is, the adoption of a tapered light pipe allows an area of the exit surface to be large, whereby it is possible to reduce an etandue of the exit surface. Consequently, it is possible to improve an illumination efficiency of a subsequent stage to the light pipe.

Although there is fear that an efficiency of utilization of light flux from the surface emission light source is sagging due to the interposition of a system (i.e. the light pipe) having an etandue smaller than that of the surface emission light source force, it becomes possible to send back the light to the surface emission light source owing to the tapered configuration of the light pipe. In particular, by doubling a dimension of the exit surface (=2a) in comparison with a dimension a of the incident surface, it is possible to maximize the light flux to be sent back to the surface emission light source. FIG. 10 shows a result of measuring a relationship between a ratio of entrance (incident) opening/exit opening and the light flux to be returned to the surface emission light source.

[Image Display Apparatus]

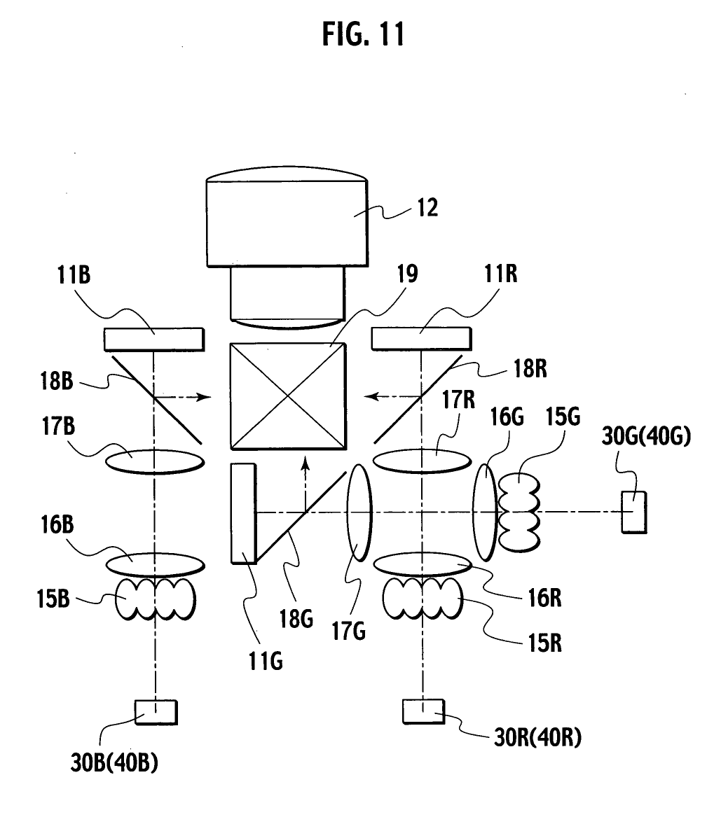

FIG. 11 is a plan view showing a constitution of an image display apparatus in accordance with the third embodiment of the present invention. In the third embodiment, constituents identical to those in the second embodiment are indicated with the same reference numerals, respectively.

As shown in FIG. 11, this image display apparatus comprises the above-mentioned polarizing illuminant apparatuses 30R, 30G, 30B (40R, 40G, 40B), spatial light modulation elements 11R, 11G, 11B illuminated by lights generated from the polarizing illuminant apparatuses 30R, 30G, 30B (40R, 40G, 40B) to modulate the illumination lights in correspondence with image signals and a projection lens 12 forming an imaging optics for producing an image through the spatial light modulation elements 11R, 11G, 11B. Thus, this image display apparatus illuminates the spatial light modulation elements 11R, 11G, 11B by means of the corresponding polarizing illuminant apparatuses 30R, 30G, 30B (40R, 40G, 40B), next combines the illumination lights through the spatial light modulation elements 11R, 11G, 11B in color thereby producing an image and finally displays the image.

The spatial light modulation elements 11R, 11G, 11B display a red component of the image on display, its green component and its blue component respectively and modulate the illumination lights in polarization corresponding to these images. The spatial light modulation elements 11R, 11G, 11B are formed by reflective light modulation elements [i.e. so-called “LCOS” (reflective liquid crystal display panel) and “DMD”] and reflect incident illumination lights in modulation.

In this image display apparatus, the polarizing illuminant apparatuses 30R, 30G, 30B (40R, 40G, 40B) generate a red light, a green light and a blue light, respectively. The polarizing illuminant apparatus 30R (40R) illuminates the spatial light modulation element 11R displaying a red component image with the red illumination light, while the polarizing illuminant apparatus 30G (40G) illuminates the spatial light modulation element 11G displaying a green component image with the green illumination light. Similarly, the polarizing illuminant apparatus 30B (40G) illuminates the spatial light modulation element 11B displaying a blue component image with the blue illumination light.

The illumination light generated from the polarizing illuminant apparatus 30R (40R) for red is equalized in terms of illumination distribution through a flyeye-lens-array 15R. The flyeye-lens-array 15R is provided, on both sides thereof, with a plurality of micro lenses (converging lenses) in matrix arrangement. The illumination light transmitted through the flyeye-lens-array 15R enters a polarization beam splitter 18R through a first field lens 16R and a second field lens 17R. This polarization beam splitter 18R, which is a reflective polarization plate, is slanted to an optic axis of the incident illumination light by 45 degrees and arranged so that the polarization direction of the incident light coincides with a P polarized light. The illumination light entering the polarization beam splitter 18R is transmitted through it and enters the spatial light modulation element 11R for red. The red illumination light is polarized in modulation by the spatial light modulation element 11R, corresponding to a red-component image signal and reflected as a red image light and enters the polarization beam splitter 18R again. The image light entering the polarization beam splitter 18R again is reflected by the polarization beam splitter 18R and enters a color combining prism (cross dichroic prism) 19.

The illumination light generated from the polarizing illuminant apparatus 30G (40G) for green is equalized in terms of illumination distribution through a flyeye-lens-array 15G. The flyeye-lens-array 15G is provided, on both sides thereof, with a plurality of micro lenses (converging lenses) in matrix arrangement. The illumination light transmitted through the flyeye-lens-array 15G enters a polarization beam splitter 18R through a first field lens 16G and a second field lens 17G. This polarization beam splitter 18G, which is a reflective polarization plate, is slanted to an optic axis of the incident illumination light by 45 degrees and arranged so that the polarization direction of the incident light coincides with a P polarized light. The illumination light entering the polarization beam splitter 18G is transmitted through it and enters the spatial light modulation element 11G for green. The green illumination light is polarized in modulation by the spatial light modulation element 11G, corresponding to a green-component image signal and reflected as a green image light and enters the polarization beam splitter 18G again. The image light entering the polarization beam splitter 18G again is reflected by the polarization beam splitter 18G and enters the color combining prism 19.

The illumination light generated from the polarizing illuminant apparatus 30B (40B) for blue is equalized in terms of illumination distribution through a flyeye-lens-array 15B. The flyeye-lens-array 15B is provided, on both sides thereof, with a plurality of micro lenses (converging lenses) in matrix arrangement. The illumination light transmitted through the flyeye-lens-array 15B enters a polarization beam splitter 18B through a first field lens 16B and a second field lens 17B. This polarization beam splitter 18B, which is a reflective polarization plate, is slanted to an optic axis of the incident illumination light by 45 degrees and arranged so that the polarization direction of the incident light coincides with a P polarized light. The illumination light entering the polarization beam splitter 18B is transmitted through it and enters the spatial light modulation element 11B for blue. The blue illumination light is polarized in modulation by the spatial light modulation element 11B, corresponding to a blue-component image signal and reflected as a blue image light and enters the polarization beam splitter 18B again. The image light entering the polarization beam splitter 18B again is reflected by the polarization beam splitter 18B and enters the color combining prism 19.

The image lights of red, green and blue entering the color combining prism 19 are combined in color and enter the projection lens 12. This projection lens 12 projects the image lights of respective colors on a not shown screen and forms an image in enlargement, performing an image displaying.

Meanwhile, when adopting the reflective spatial light modulation elements, such as so-called “LCOS”, for the spatial light modulation elements 11R, 11G, 11B, like as the above-mentioned image display apparatus does, unnecessary lights at black displaying return toward the light sources. However, according to the image display apparatus of this embodiment, the unnecessary lights at black displaying returning to the light sources are suppressed from being reflected by the respective polarizing illuminant apparatuses 30R, 30G, 30B (40R, 40G, 40B) again, so that an occurrence of so-called “black floating” phenomenon can be restrained.

That is, in this image display apparatus, the illumination lights reflected by the spatial light modulation elements 11R, 11G, 11B at black displaying return to the polarizing illuminant apparatuses 30R, 30G, 30B (40R, 40G, 40B), in the form of linear polarized lights having the same directions of polarization as the illumination lights from the polarizing illuminant apparatuses 30R, 30G, 30B (40R, 40G, 40B), respectively. In each of the polarizing illuminant apparatuses 30R, 30G, 30B (40R, 40G, 40B), each return light is transmitted through the reflective polarization plate 24 and further the quarter wave plate 23 (we continue our descriptions while omitting the collimator lenses 26 because of the descriptions about polarization). When passing through the quarter wave plate 23, this return light is changed to a circularly polarized light. Then, the return light is reflected by the photonic crystal 2, in the form of a circularly polarized light in the opposite direction. When reaching the reflective polarization plate 24 through the quarter wave plate 23, this reflected light is reflected by the reflective polarization plate 24 since the same light has become a linear polarized light in a direction unable to be transmitted through the reflective polarization plate 24. Then, this reflected light is transmitted through the quarter wave plate 23 again and reaches the photonic crystal 2. Then, the reflected light is further reflected by the photonic crystal 2 and reaches the reflective polarization plate 24 through the quarter wave plate 23. Although this light has become a linear polarized light in a direction to be transmitted through the reflective polarization plate 24, it is attenuated due to such multiple-reflections, so that respective intensities of the lights reaching the spatial light modulation elements 11R, 11G, 11B are reduced.

Additionally, in the image display apparatus of the embodiment, there is no possibility that an etandue of each light source increases. Further, as the utilization efficiency of light from the light sources is high, the image display apparatus can display high-quality and bright images.

Note that the image display apparatus of this embodiment is not limited to the above-mentioned constitution adopting reflective spatial light modulation elements as the spatial light modulation elements 11R, 11G, 11B and therefore, transmission light modulation elements may be adopted as the spatial light modulation elements 11R, 11G, 11B. Additionally, the flyeye-lens-arrays 15R, 15G, 15B may be replaced with either rod integrators or light-tunnel (light pipe) integrators.

In the polarizing illuminant apparatus of the present invention, as obvious from above, a polarized light component, which is included in the lights emitted from the surface emission light source and transmitted through the photonic crystal and the quarter wavelength plate and of which direction is different from a linear polarized light in a designated direction, is reflected by the reflective polarization plate and further transmitted through the quarter wave plate and returns to the photonic crystal. This returning light is reflected by the photonic crystal so that the direction of polarization rotates by 180 degrees. The reflected light is transmitted through the quarter wave plate again and reaches the reflective polarization plate. Then, this light has become a linear polarized light in the designated direction that can pass through the reflective polarization plate. Thus, the same light is transmitted through the reflective polarization plate and emitted outside. Consequently, according to the polarizing illuminant apparatus, it is possible to effectively align the lights emitted from the surface emission light source to the linear polarized lights in the designated direction for emission.

Additionally, if only closing the opening part of the can-shaped body accommodating the surface emission light source by the quarter wavelength plate and the reflective polarization plate surface, then it is possible to prevent dust from polluting or adhering to the surface emission light source and the photonic crystal.

As for the polarizing illuminant apparatus of the invention, still further, if only arranging the photonic crystal in an area corresponding to a light emitting surface of the surface emission light source, there is no possibility an etandue of the light source increases in comparison with an arrangement having no photonic crystal. In other words, since the etandue of the light source does not change at a polarization changing in the polarizing illuminant apparatus, it is possible to reduce a light loss caused by restraining

Further, since the light pipe is tapered so as to make an area of the incident surface larger than an area of the exit surface, it is possible to send the light back to the surface emission light source effectively. Namely, owing to an adoption of the tapered light pipe, it becomes possible to reduce the area of the exit surface, allowing an etandue of the exit surface to be reduced. Consequently, it is possible to improve an illumination efficiency of a subsequent stage to the light pipe.

Although there is fear that an efficiency of utilization of light flux from the surface emission light source is sagging due to the interposition of a system (i.e. the light pipe) having an etandue smaller than that of the surface emission light source force, it becomes possible to send back the light to the surface emission light source owing to the tapered configuration of the light pipe. In particular, by substantially doubling respective dimensions of the exit surface in comparison with respective dimensions of the incident surface, it is possible to maximize the light flux to be sent back to the surface emission light source.

Additionally, the present image display apparatus having the above-mentioned polarizing illuminant apparatus can display high-definition and bright images because the polarizing illuminant apparatus allows the utilization efficiency of light from the light source to be enhanced without increasing the etandue of the light source

When adopting a reflective liquid crystal display panels (LCOS) as the spatial light modulation element, unnecessary lights at black displaying return toward the light sources. However, according to the image display apparatus of this embodiment, the unnecessary lights at black displaying returning to the light sources are suppressed from being reflected by the polarizing illuminant apparatus again, so that an occurrence of “black floating” phenomenon can be restrained.

In conclusion, the present invention can provide a polarizing illuminant apparatus that is constructed so as to enable an effective polarization change of lights emitted from a surface emission light source without changing an etandue of an optical system containing the polarizing illuminant apparatus, and also an image display apparatus having the polarizing illuminant apparatus.

Finally, it will be understood by those skilled in the art that the foregoing descriptions are nothing but embodiments and various modifications of the disclosed polarizing illuminant apparatus and the image display apparatus having the polarizing illuminant apparatus and therefore, various changes and modifications may be made within the scope of claims.

What is claimed is:

1. A polarizing illuminant apparatus comprising:
a surface emission light source that emits a monochroic and indefinitely polarized light;
a tabular photonic crystal arranged on a light emitting surface of the surface emission light source to receive the light emitted from the light emitting surface;
a quarter wave plate that receives a light emitted from the surface emission light source and transmitted through the photonic crystal; and
a reflective polarization plate arranged in substantially-parallel with the photonic crystal to receive a light transmitted through the quarter wave plate.

2. The polarizing illuminant apparatus of claim 1, further comprising
a can-shaped body that accommodates the surface emission light source and that is opened in an exit direction of the light emitted from the surface emission light source, wherein
the quarter wave plate and the reflective polarization plate are attached to the can-shaped body so as to close an opening part of the can-shaped body.

3. The polarizing illuminant apparatus of claim 1, wherein the photonic crystal is arranged in an area corresponding to the light emission surface of the surface emission light source.

4. The polarizing illuminant apparatus of claim 1, further comprising
a collimator that receives the light emitted from the surface emission light source and transmitted through the photonic crystal, wherein
the quarter wave plate receives a light transmitted through the collimator.

5. The polarizing illuminant apparatus of claim 1, further comprising:
a light pipe that receives the light emitted from the surface emission light source and transmitted through the photonic crystal; and
a collimator that receives a light transmitted through the light pipe photonic crystal, wherein
the quarter wave plate is arranged on either an incident side of the collimator or an exit side thereof.

6. The polarizing illuminant apparatus of claim 5, wherein the light pipe has a rectangular incident surface and a rectangular exit surface, and the light pipe is tapered so as to have an area of the exit surface larger than an area of the incident surface.

7. The polarizing illuminant apparatus of claim 5, wherein the light pipe has rectangular incident and exit surfaces, and one side of the incident surface is substantially twice as long as one side of the exit surface corresponding to the one side of the incident surface.

8. An image display apparatus comprising:
a polarizing illuminant apparatus of claim 1;
a spatial light modulation element that is illuminated by an illumination light emitted from the polarizing illuminant apparatus to modulate the illumination light in correspondence with an image signal; and
an imaging optics that focuses into an image by the spatial light modulation element.

9. The image display apparatus of claim 8, wherein the spatial light modulation element is a reflective liquid crystal display panel.
